(19) United States
(12) Patent Application Publication
(10) Pub. No.: US 2007/0067205 A1
(43) Pub. Date: Mar. 22, 2007

(54) Industry associated referral marketing system and method

(76) Inventor: Richard K. Stanley, Leawood, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/372,493

(22) Filed: Mar. 10, 2006

Related U.S. Application Data
(60) Provisional application No. 60/660,838, filed on Mar. 10, 2005.

(51) Int. Cl. G06F 17/30

(52) U.S. Cl. 705/10

(57) ABSTRACT

A referral marketing system and method is provided that allows for the marketing of goods or services of a provider to its customer by aiding in the marketing of the goods/services of the customer. In a preferred embodiment the system and method of the instant invention is used to market appraisal services to loan officers by assisting the loan officers in marketing to referral sources of the loan officers. The system provides email notices to the referral sources of the loan officer that appear to be sent from the loan officer, but that are sent by the appraiser as part of the appraisal service.

This application claims priority pursuant to 35 U.S.C. 119(e) to co-pending U.S. Provisional Patent Application Ser. No. 60/660,838, filed Mar. 10, 2005, the entire disclosure of which is incorporated herein by reference.

### FIELD OF THE INVENTION

The present invention relates generally to systems and methods of marketing goods or services. More specifically, the present invention is concerned with a system and method of marketing the goods or services of a provider to its customer by aiding in the marketing of the goods/services of the customer.

### BACKGROUND OF THE INVENTION

The residential appraisal industry offers a service to loan officers that is largely regarded as a commodity (the real estate appraisal). The decision by the loan officer as to which appraiser will be used is often determined by price, speed of service, or the aggressiveness of the value conclusions. There are very few (if any) other items that the typical appraisal firm has available to offer that would be appealing to the loan officer marketplace. As appraisers (by their ethical standards) are not supposed to be aggressive in their value conclusions, that method is limited to a small, yet, growing, portion of the marketplace. Reducing appraisal fees below the standard fees of the past 8-10 years is difficult for any industry and largely undesirable. Speed service is offered by virtually all firms as the time involved in performing a residential appraisal is 4-6 hours and the typical mortgage loan takes 15-30 days to close. This is to say that speed is often not actually required. Therefore, it would be beneficial to provide a way for an appraisal firm to set its services apart from those of its competitors.

Prior art systems are available to appraisers that allow online ordering and review of appraisals. For example, the E-Trac system offers an on-line appraisal order database application that is accessible by both the appraisal shop and its clients (i.e. the mortgage companies). The E-Trac system is similar to many other systems available in other industries, and does provide a slight service advantage to appraisers using such systems; however, that benefit is typically not enough to be a deciding factor for a loan officer to select one appraiser over another.

Several marketing companies offer follow up postcard marketing campaigns, which may be purchased by businesses such as mortgage companies following the closing of a sale to market their services to their former customers. These are generally accomplished through the US postal service. These campaigns are generally limited to the period after the loan closes and are not specific to the transaction. These are merely campaigns that are generic in nature in order to maintain exposure of the loan officer to the borrower. These campaigns are purchased directly by the loan officer, are entirely unrelated to the appraisal process, and therefore provide no way for an appraiser to set its services apart from those of its competitors.

### SUMMARY OF THE INVENTION

The present invention comprises a marketing system and method that markets the goods or services of a provider, such as a real estate appraiser, by aiding in marketing the goods/services of the provider's customer. Marketing pieces are offered to the customer along with the goods/services traditionally provided by the provider. The marketing pieces allow the provider to set its goods/services apart from those of competitors, when such goods/services are traditionally regarded as a commodity.

In a preferred embodiment, the system of the instant invention is designed for residential real estate appraisers to use in attracting and maintaining residential loan officers as clients. The system does not market the services of the appraiser, but rather, his/her client, the loan officer. The basic idea is to help the loan officer increase his/her referral business by marketing the loan officer to his/her three key referral contacts:
Listing Agent
Selling Agent
Borrower

This is done thru a series of e-mail pieces that appear to be coming from the loan officer; however, they are being generated by the system that is operated by the appraiser. When certain events are accomplished during the appraisal process, these e-mail notices are automatically generated. To the email recipients, it does not appear as though the emails are being sent out by the appraisal office. Instead the emails appear to be the efforts of the loan officer. These emails and events include the following:

| E-mail Title | When it is sent | Sent to |
|---|---|---|
| Confirmation | When the appraisal order | Loan officer/Processor |
| | is placed | |
| Report card | When the appraisal is | Loan officer/Processor |
| | delivered | |
| Appraisal | When the appointment is | Selling Agent |
| Scheduled | set | |
| Appraisal | When the appraisal is sent | Selling/Listing Agents |
| Completed | | |
| House | When the appraisal is sent | Borrower |
| picture | | |
| Survey | 1 week after the | Borrower |
| | appraisal is sent | |
| Video | 2 weeks after the | Borrower |
| | appraisal is sent | |
| Follow up | 6 times for next 3 years | Borrower |
| campaign | | |

The system and method of the instant invention provides a unique opportunity for the appraiser to market his/her service and not be as concerned with the pressures of aggressive value conclusions and price. Through the instant invention the emphasis is placed on the extended marketing services that the appraisal firm offers with the appraisal order that assists the loan officer in gaining future business thru referrals.

Although the inventive system and method is beneficial during all of the cycles of the appraisal industry, it is especially beneficial at present due to the large number of individuals that have entered the industry in the past 5 years and the return of the marketplace volume to normal levels. This is to say that obtaining enough work for a typical residential appraisal shop is difficult at present.

Unlike the prior art systems used by appraisers that only allow online ordering and review of appraisals, the instant invention provides correspondence to the listing agent, selling agent or borrowers regarding the appraisal and furthermore, markets the mortgage company (or its employees) to its customers/referral sources. The instant invention provides a complete system for a mortgage company to purchase follow-up marketing (or any marketing) services as part of the appraisal process. The appraiser markets the services of the mortgage company (either directly or through a third party service purchased by the appraiser) as an additional service as part of the appraisal process. In the preferred embodiment of the instant invention, this follow-up marketing is performed via email.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a schematic flow diagram of a preferred embodiment of the present invention.

FIG. 2 is a sample screen shot of a “Confirmation & Thank You” email described in FIG. 1.

FIG. 3 is a sample screen shot of a “Completed Appraisal and Report Card” email described in FIG. 1.

FIG. 4 is a sample screen shot of an “Appraisal Scheduled” email described in FIG. 1.

FIG. 5 is a sample screen shot of an “Appraisal is Complete” email described in FIG. 1.

FIG. 6 is a sample screen shot of a “Picture of the House” email described in FIG. 1.

FIG. 7a-7b are sample screen shots of a “Survey & ask for referral” email described in FIG. 1.

FIG. 8 is a sample screen shot of a “Thank you & referral video” email described in FIG. 1.

FIGS. 9 and 10 show sample screen shots of the follow-up emails from the loan officer to the borrower described in FIG. 1.

FIG. 11 shows a sample screen shot of a setup page for marketing function of a

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

A preferred embodiment of the instant invention markets an appraiser's clients (the loan officer) to their own referral sources (listing agent, selling agent, borrower). The appraisal is ordered by the loan officer online via a website of the appraiser. The website may be an independent website operated by the appraiser, or alternatively, in the preferred embodiment, the website is a webpage dedicated to the appraiser that is part of a central website operated by an independent third party. In the preferred embodiment, the independent third party operates the central website and database for multiple appraisers that are using the system and marketing method of the instant invention. Data regarding the appraisal (i.e. address of property, names of borrower and loan officer, email addresses and other contact information of borrower and loan officer, date ordered, requested completion date, loan amount, date appraisal completed, appraised value, etc.) is stored in the database for access by the appraiser and/or the loan officer ordering the appraisal. A computer program associated with the database automatically generates targeted email messages that are sent to the loan officer and the loan officer's referral sources throughout the appraisal processes using and/or triggered by information stored in the database.

The system of the instant invention offers the appraisal shop the ability to monitor its workload among its employees and contractors through a custom, central database (central file). This central file is used by office staff and the appraisers to update the progress of appraisals via the internet. The system of the instant invention also serves as a storage location for appraisal files that have already been completed. It provides for monitoring of the progress made by the appraiser and offers (or allows for) communication between the employees of the appraisal shop. It can be accessed from the office or at remote locations (personal homes). This is becoming increasingly important as the industry is often characterized by independent contractors that work from home.

Access to the database is granted to the mortgage companies that are clients of the appraisers to place orders on-line and to monitor the status of the appraisal as it moves from the initial contact through delivery. The client (mortgage company) also has access online to appraisal files that have already been delivered to that client. This provides the client information that is necessary in order for an on-time closing or to assist an anxious realtor/borrower. At the time the order is placed online, the computer program of the inventive system provides the loan officer with a printed copy of their appraisal order for verification purposes. Once the order has been received and assigned by the appraisal firm, the system generates a confirmation (as shown in FIG. 2) that is automatically sent to the loan officer and the loan processor. At the time that the appraisal is delivered to the client (loan officer) via email, the email correspondence includes a “Report Card” on the results of the service that was delivered, the details of which are discussed below.

The system of the preferred embodiment comprises a central database that is operated by an independent third party to store information of multiple independent appraisers. Each appraiser contracting with the third party service provider has its own web page that appears to be controlled or operated by the independent appraiser, but which is connected to the third party database. The database stores information regarding appraisals ordered via an appraiser's webpage, including but not limited to the name, company, address, email, etc. of the loan officer ordering the appraisal from the specific appraiser, address of property, names of borrower, email other contact information of borrower, date appraisal is ordered, requested completion date for the appraisal, loan information useful during appraisal such as loan amount, date appraisal completed, appraised value, etc. In a preferred embodiment, the database also stores an electronic copy of the completed appraisal for future access by the appraiser and the loan officer. In one embodiment of the instant invention, a loan officer can register with the third party by storing information about the loan officer (such as name, address, phone number, email, etc.) and associate that information with pre-stored information regarding the appraiser in the database. In this embodiment, the loan officer can easily request multiple appraisals from the appraiser without the need to reenter the loan officer's contact information for every appraisal.

It will be appreciated that the central database of the preferred embodiment of the instant invention can be a single database that separately stores or otherwise associates data regarding specific orders with the specific appraiser that is utilizing the system, or alternatively, the central database may comprise multiple independent databases, in which a single database is dedicated to each appraiser. Furthermore, it will be appreciated that multiple databases may exist as multiple independent pieces of hardware, or alternatively, multiple databases may exist as multiple (i.e. partitioned) storage locations in a single piece of hardware.

The system of the instant invention provides multiple service levels for selection by the loan officer when the loan officer orders an appraisal, with different service levels offering different marketing opportunities of the loan officer. Based upon the service level selected by the loan officer (the service level chosen is also stored in the database), a computer program of the system of the instant invention accesses information from the database at different times throughout the appraisal process and automatically sends email messages. The email messages are shown and described in more detail below. Some of the email messages are from the appraiser to the loan officer (i.e. confirmation of order, completed appraisal), while others are sent from the loan officer to the loan officer's referral sources (i.e. appraisal to borrower, selling/listing agents, etc., and other marketing/informational emails). In the preferred embodiment, the email messages are sent from the third party service provider; however the “from” email address is displayed to the recipient as that of the appraiser (in the emails directed from the appraiser) or the loan officer (in the emails from the loan officer).

In the preferred embodiment, several emails requests include links to contact either the appraiser or the loan officer. These links may be a direct email that goes to the intended recipient (i.e. the appraiser's direct email or the loan officer's direct email), or it can be an address of the third party service provider. In the case of the address being that of the third party service provider, the data contained in the communication may be stored in the database and the information is then forwarded to the intended recipient (appraiser or loan officer) by the system of the instant invention. Depending upon the specific message and information requested, some links may provide direct communication to the recipient (i.e. appraiser/loan officer) while others go through the third party service provider. For example, in a preferred embodiment, a link to send the appraiser or the loan officer an email or to send the name of someone for the loan officer to contact, goes directly to the recipient. Alternatively, a link to complete a survey evaluating the loan officer's performance in a preferred embodiment goes to a website operated by the third party. The third party (or a computer program controlled by the third party) collects the survey results and forwards the results to the loan officer via email, or alternatively the loan officer may access the results by accessing the central database.

Referring to FIG. 1, a schematic flow diagram of a preferred embodiment of the present invention is shown used in connection with an order for a residential real estate appraisal. As is shown in FIG. 1, the preferred embodiment of the invention provides the client (mortgage company, or loan officer) with several service levels from which to select, including, standard, premium and premium plus. The standard service level shown in FIG. 1 includes emails that are generated by the system (or computer program) of the instant invention as part of the appraisal service and at no extra charge to the client. As is shown in FIG. 1, this standard service includes “Confirmation & Thank You”, and “Completed Appraisal and Report Card” email messages that are automatically sent to both the loan officer and the processor assisting the loan officer. The premium service level shown in FIG. 1 includes additional email messages that are sent to the referral sources of the client as part of the appraisal service. In the preferred embodiment, the premium service level shown in FIG. 1 is provided to the client at no extra charge, as it is offered by the appraiser to the client to add value or to set the appraiser's services apart from those of its competitors. Alternatively, however, the premium service level can be provided at an increased cost to the client. As is shown in FIG. 1, the premium service includes an “Appraisal Scheduled” email message to the selling agent, an “Appraisal is Complete” email message that is sent to the listing agent and to the selling agent, and “Picture of the House” and “Survey & ask for referral” email messages that are sent to the borrower. The premium plus service level shown in FIG. 1 includes yet additional email messages or promotional items that are sent to the referral sources of the client to further market the client's services. In the preferred embodiment the premium plus service level is marketed to the client at an extra charge that is in addition to the cost of the appraisal service. As is shown in FIG. 1, the premium plus service includes postcards that are sent to the borrower prior to closing that includes information about the borrower's new home for the borrow to send to friends and family, a “Thank you & referral video” that is emailed to the borrower after closing, and a series of follow-up emails that are sent to the borrower at various times following closing.

Referring to FIG. 2, a screen shot of a “Confirmation & Thank You” email described in FIG. 1 is shown. In the preferred embodiment, the email is automatically generated by the system of the instant invention after information regarding an appraisal order is entered into the database. The purpose of this email is to confirm to the client that the appraisal order has been made, and to thank the client for the business. The appraisal order is entered into the database either by the appraiser after receiving an order, or in the case of the preferred embodiment in which orders are made online, by the client by accessing the website of the appraiser. The computer program of the instant invention uses the data in the database, such as the email address of the client (load officer and/or processor), address of the property to be appraised, borrower name, etc., to create and send the email of FIG. 2. In the preferred embodiment in which the database is operated by an independent third party, the email shown in FIG. 2 will appear to be sent from the appraiser (i.e. have the “from” address of the appraiser), even though the email message is actually generated by the third party system. The email of FIG. 2 includes a link titled “Go to ‘My Appraisals’ list”, which in the preferred embodiment links the client to the database of the instant invention to allow the client to review information regarding all appraisal orders made by that client and stored in the database.

Referring to FIG. 3, a screen shot of an “Appraisal Scheduled” email described in FIG. 1 is shown. The email shown in FIG. 3 includes: A) the appraisal attached in PDF format; B) a link to the appraisal for download from the web site (stored in the database) of the appraiser; and C) a report card in which the appraisal service is rated and displayed for loan officer to review. In the preferred embodiment, the email is automatically generated by the system of the instant invention after the appraisal has been completed and a copy of the appraisal has been stored into the database. The appraisal is stored/uploaded into the database by the appraiser in a PDF format for easy download and email. The computer program of the instant invention uses the data in the database, such as the email address of the client (load officer and/or processor), address of the property to be appraised, etc., to create and send the email of FIG. 3. In the preferred embodiment in which the database is operated by an independent third party, the email shown in FIG. 3 will appear to be sent from the appraiser (i.e. have the “from” address of the appraiser), even though the email message is actually generated by the third party system. The email of FIG. 3 also includes a link titled “Go to ‘My Appraisals’ list”, which in the preferred embodiment links the client to the database of the instant invention to allow the client to review information regarding all appraisal orders made by that client and stored in the database. In addition, a link is included that directs an email correspondence from the client to the appraiser.

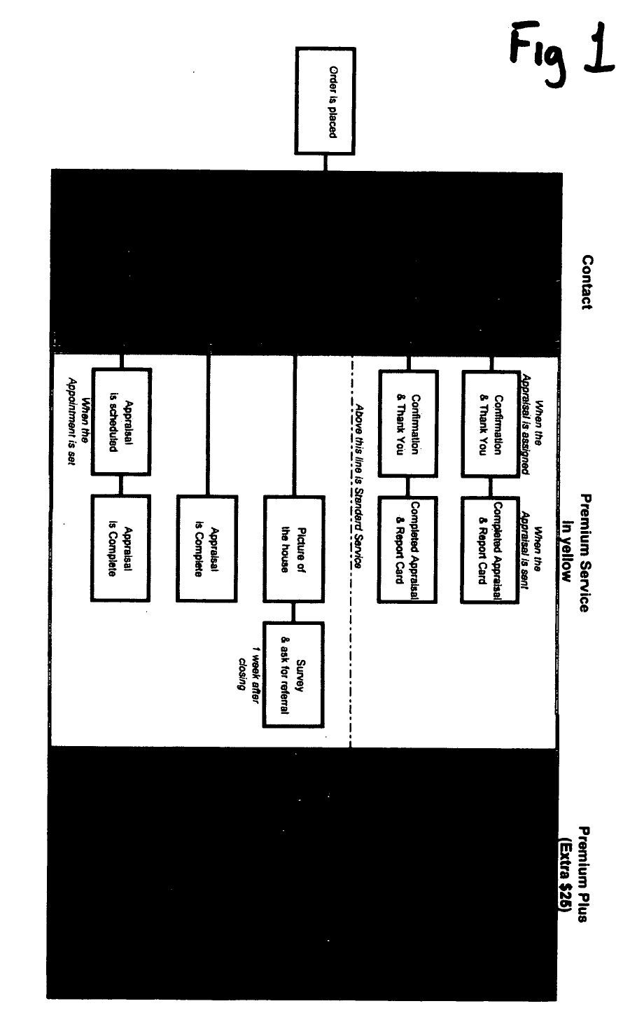

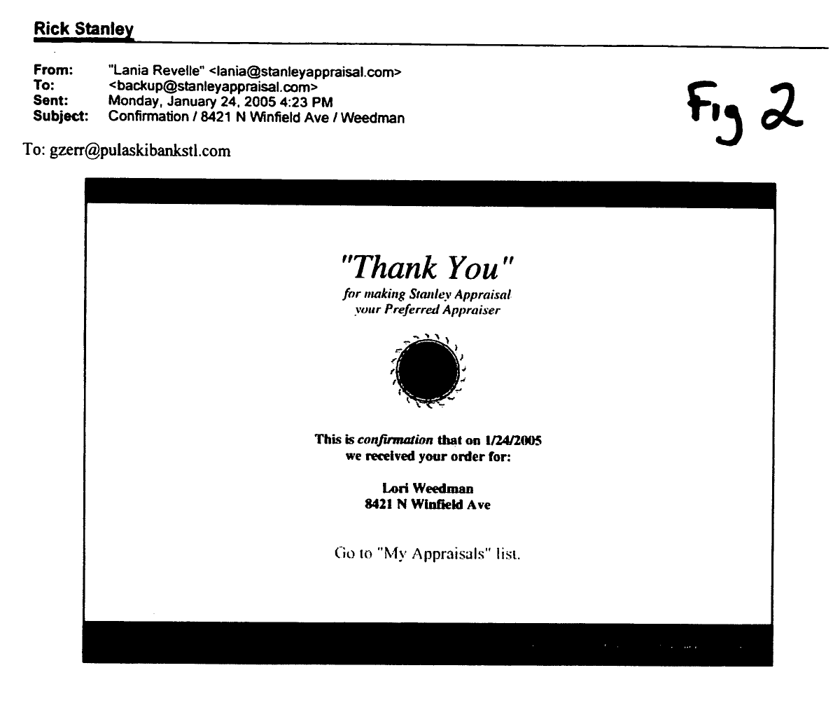

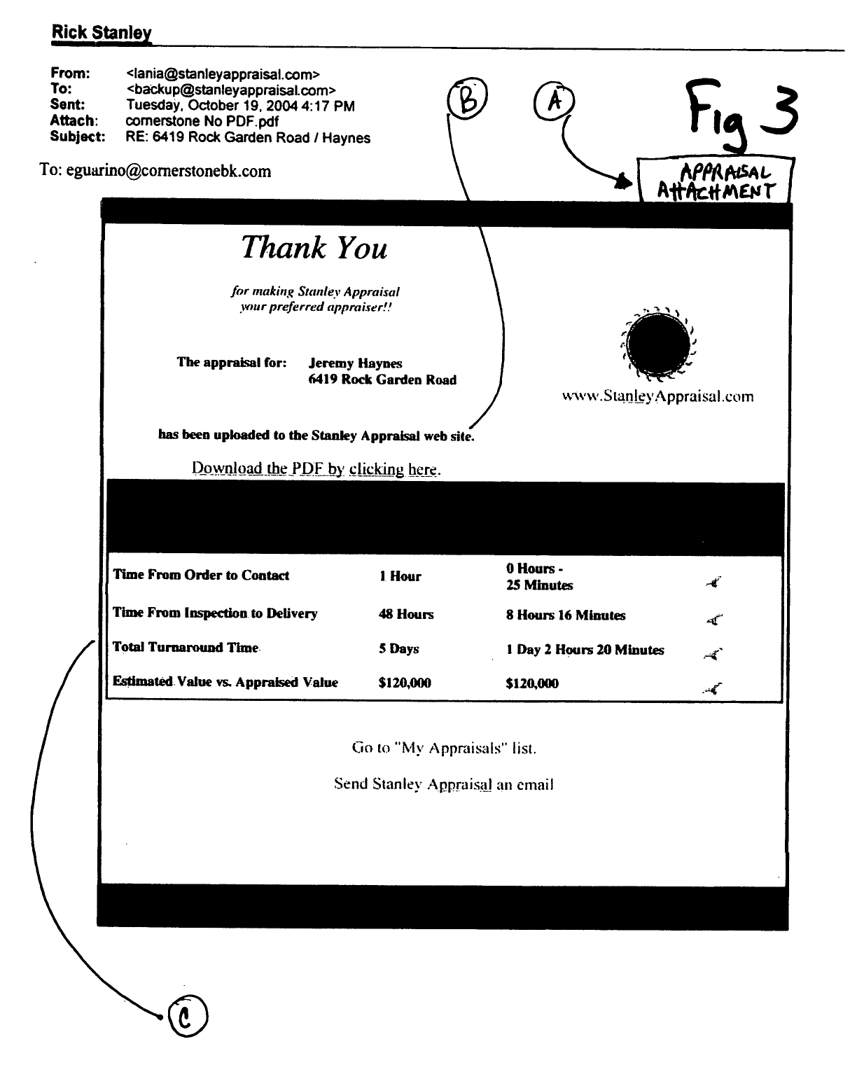

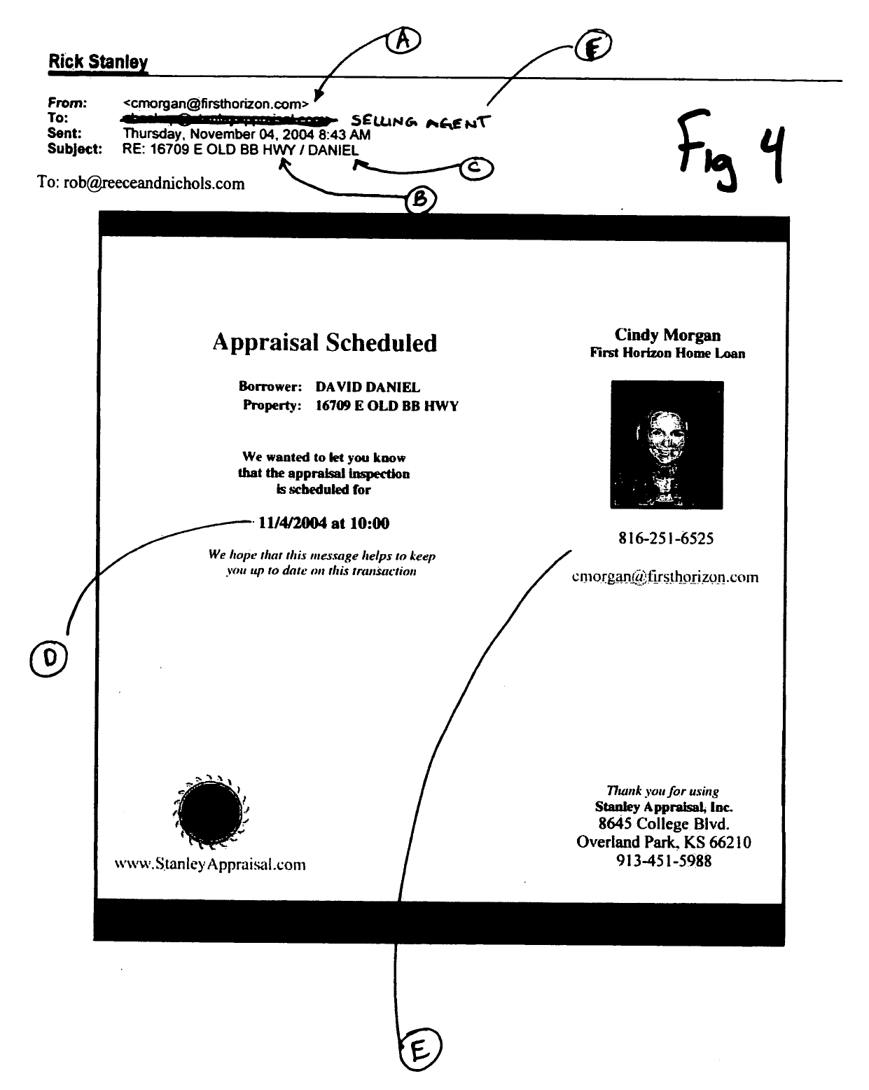

Referring to FIG. 4, a screen shot of a “Completed Appraisal and Report Card” email described in FIG. 1 is shown. The email shown in FIG. 4 includes: A) the email from address of the loan officer (client); B) subject line display of the property being appraised C) subject display of the borrower's last name; D) display of the date and time of the appointment to conduct the appraisal; E) display of the loan officer's photo, name, company name, phone #, and email address; and F) email address of the selling agent. In the preferred embodiment, the email is automatically generated by the system of the instant invention after the appraisal has been scheduled and the date of the appointment has been entered into the database by the appraiser. The computer program of the instant invention uses the data in the database, such as the contact information for the loan officer, address of the property to be appraised, selling agent's email address, appointment date and time, etc., to create and send the email of FIG. 4. In the preferred embodiment in which the database is operated by an independent third party, the email shown in FIG. 4 will appear to be sent from the loan officer (i.e. have the “from” address of the loan officer), even though the email message is actually generated by the third party system. In the preferred embodiment, contact information for the appraiser, and a link to the appraiser's website is also included in the email.

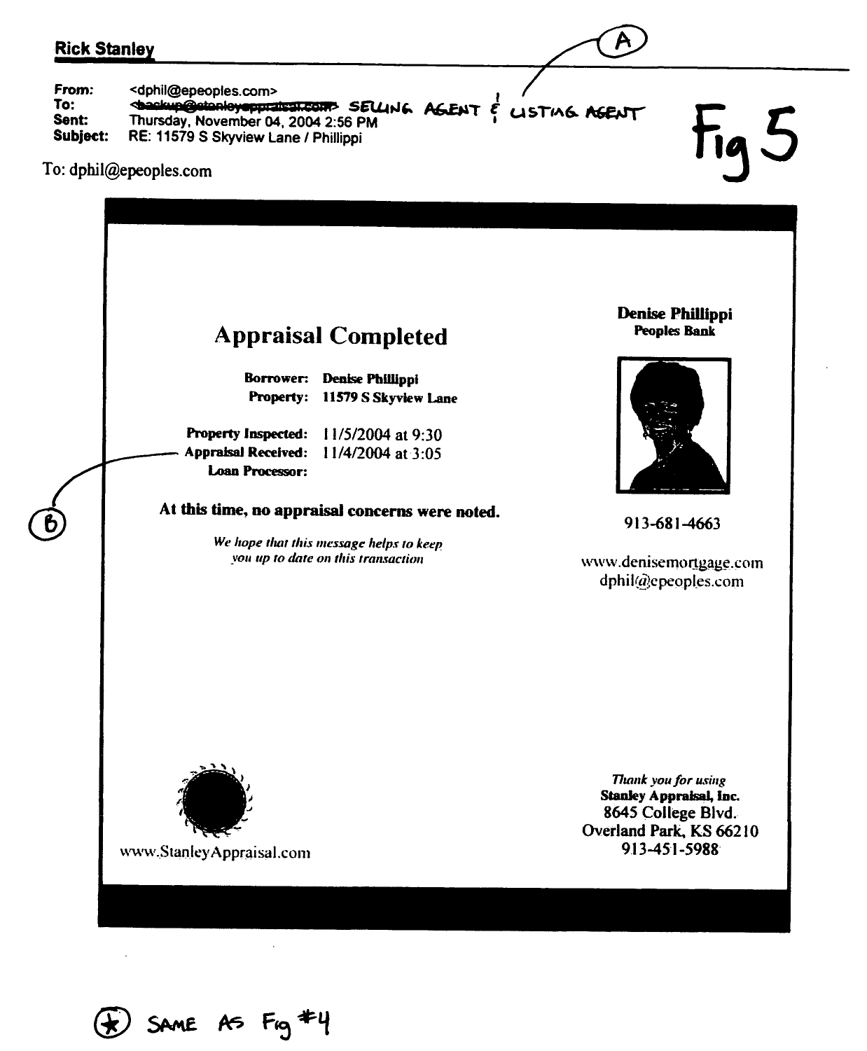

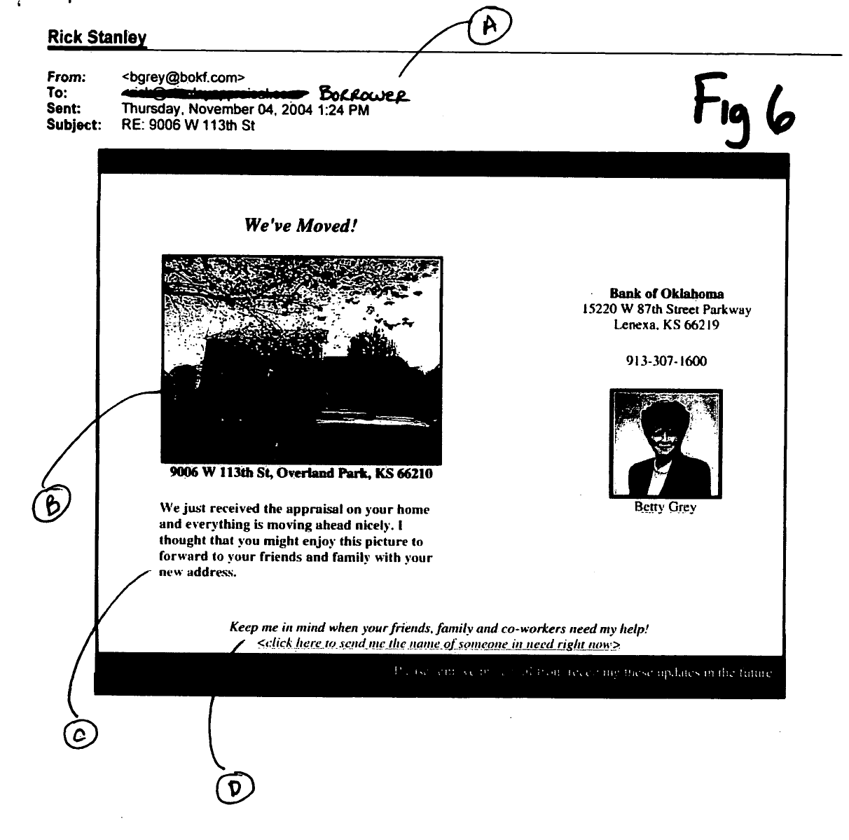

Referring to FIG. 5, a screen shot of a “Appraisal is Complete” email described in FIG. 1 is shown. The email shown in FIG. 5 includes: the email from address of the loan officer (client); subject line display of the property being appraised subject display of the borrower's last name; display of the date and time of the appointment to conduct the appraisal; display of the loan officer's photo, name, company name, phone #, and email address; and email address of the selling agent, as is discussed above with respect to FIG. 4. In addition, the email shown in FIG. 5 includes: A) the email address of the listing agent as well as that of the selling agent; and B) display of the date and time that appraisal was received by the loan officer. In the preferred embodiment, the email is automatically generated by the system of the instant invention after the appraisal has been completed and uploaded into the database. The computer program of the instant invention uses the data in the database, such as the contact information for the loan officer, address of the property to be appraised, selling agent's email address, listing agent's email address, appointment date and time, date and time appraisal received, etc., to create and send the email of FIG. 5. In the preferred embodiment in which the database is operated by an independent third party, the email shown in FIG. 5 will appear to be sent from the loan officer (i.e. have the “from” address of the loan officer), even though the email message is actually generated by the third party system. In the preferred embodiment, contact information for the appraiser, and a link to the appraiser's website is also included in the email.

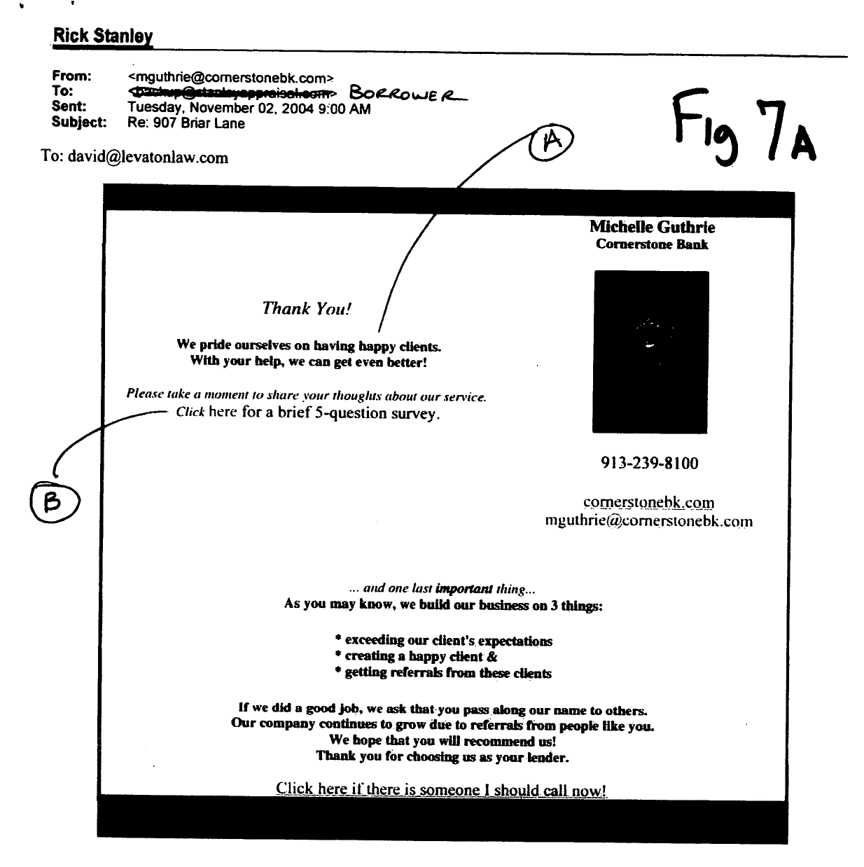

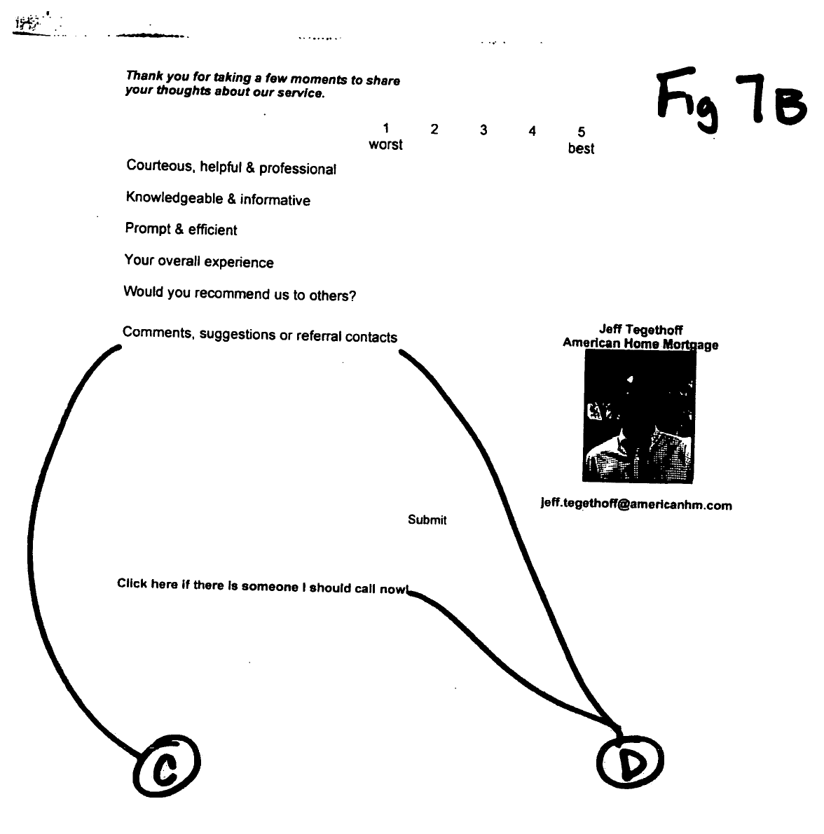

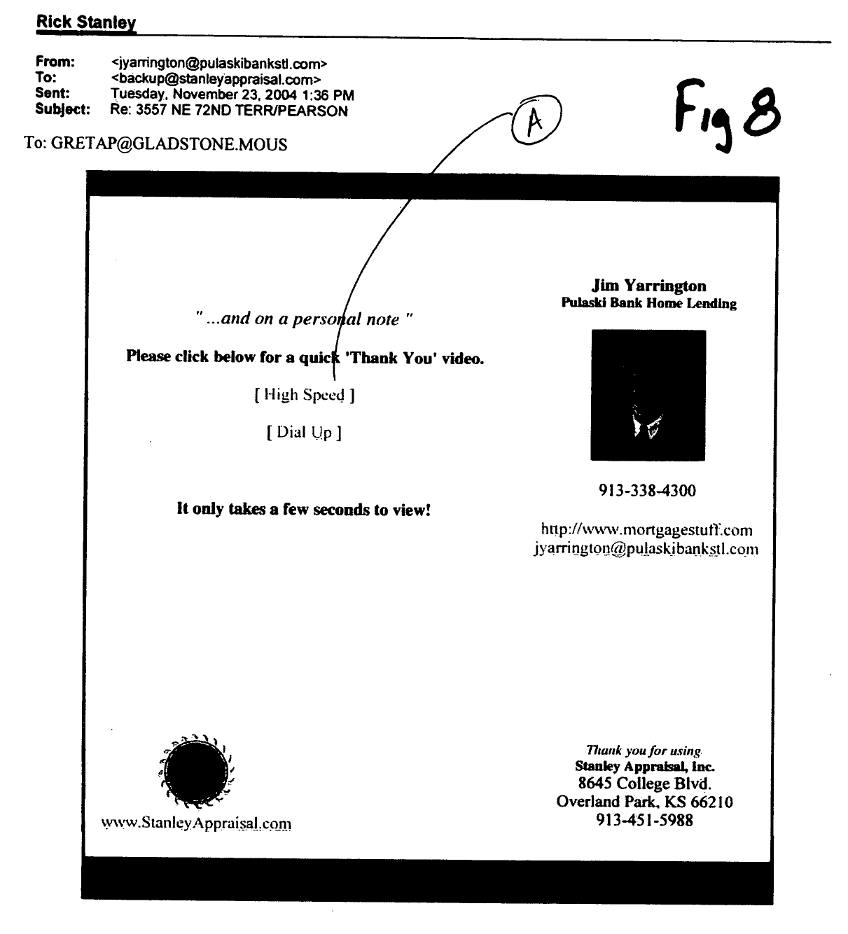

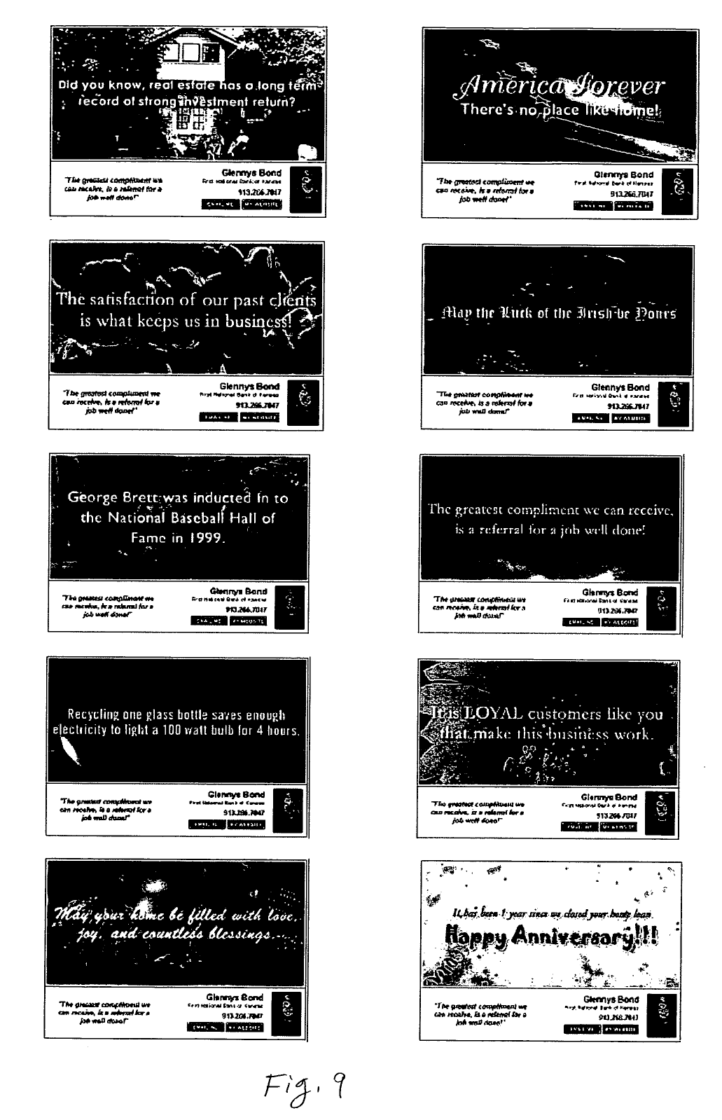

Referring to FIGS. 7a and 7b, screen shots of a “Survey & ask for referral” email described in FIG. 1 is shown. The email shown in FIG. 7a includes: the email from address of the loan officer (client); subject line display of the property being appraised; and display of the loan officer's photo, name, company name, phone #, and email address, in the same manner discussed above with respect to FIG. 4. In addition, the email of FIG. 7a includes and is sent to the email address of the borrower; as well as A) a thank you from the loan officer to the borrower; B) a request and link for the borrower to complete a survey. The survey to which the borrower is linked is shown in FIG. 7b, and includes: C) comments that are forwarded to the loan officer; and D) a request for the borrower to refer clients to the loan officer. In the preferred embodiment, the email is automatically generated by the system of the instant invention one week after the appraisal has been completed and the appraisal is uploaded into the database. The computer program of the instant invention uses the data in the database, such as the contact information for the loan officer, address of the property to be appraised, borrower's email address, etc., to create and send the email of FIG. 7a. In the preferred embodiment in which the database is operated by an independent third party, the email shown in FIG. 7a will appear to be sent from the loan officer (i.e. have the “from” address of the loan officer), even though the email message is actually generated by the third party system.

Referring to FIG. 8, a screen shot of a “Thank you & referral video” email described in FIG. 1 is shown. The email shown in FIG. 8 includes: the email from address of the loan officer (client); subject line display of the property being appraised; and display of the loan officer's photo, name, company name, phone #, and email address, in the same manner discussed above with respect to FIG. 4. In addition, the email of FIG. 8 includes and is sent to the email address of the borrower; as well as A) a thank video from the loan officer to the borrower that has been uploaded by the loan officer into the database. The borrower clicks on this link and a video of the loan officer begins to play and thanks the borrower and asks for referrals. In the preferred embodiment, the email is automatically generated by the system of the instant invention two weeks after the appraisal has been completed and the appraisal is uploaded into the database. The computer program of the instant invention uses the data in the database, such as the contact information for the loan officer, address of the property to be appraised, borrower's email address, etc., to create and send the email of FIG. 8. In the preferred embodiment in which the database is operated by an independent third party, the email shown in FIG. 8 will appear to be sent from the loan officer (i.e. have the “from” address of the loan officer), even though the email message is actually generated by the third party system.

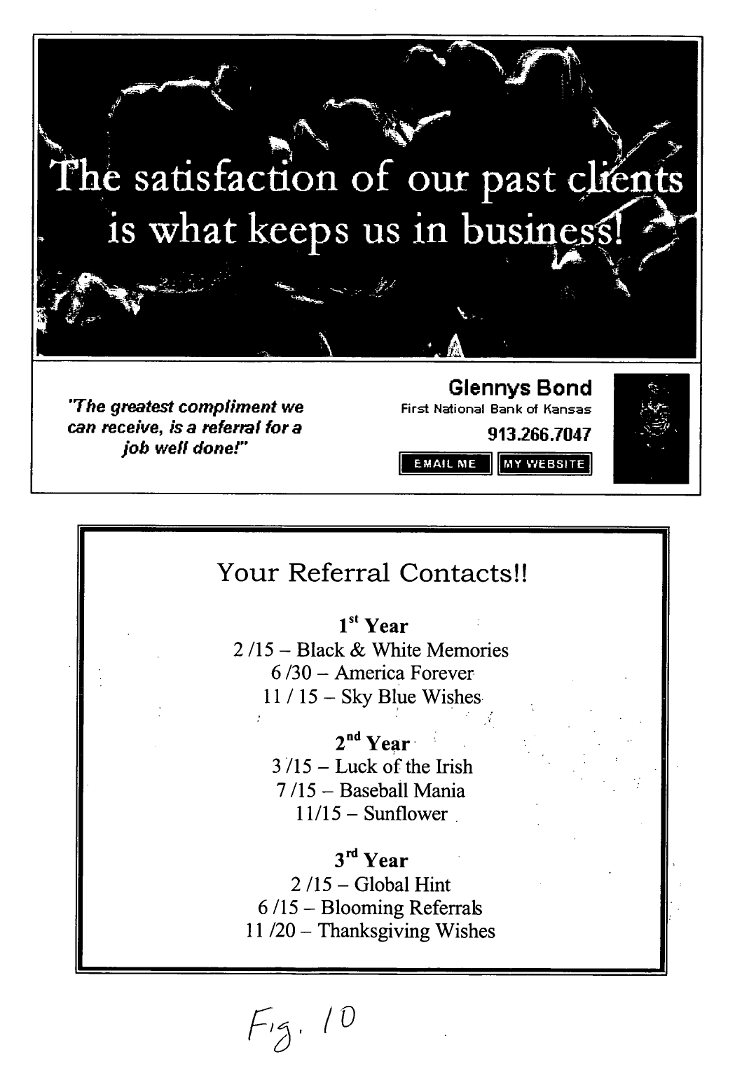

Referring to FIGS. 9 and 10, follow up emails that are automatically sent by the system of the instant invention to the borrow on behalf of (and showing the “from” email address of) the loan officer/client or shown. FIG. 9 shows ten examples of follow up emails that appears to be from the loan officer and which provide exposure of the loan officer to the borrower in an effort to gain future business and future referrals. The ten emails of FIG. 9 are sent to the borrower at different times throughout a period of time following the closing. In the preferred embodiment, the ten emails are sent out at various times throughout a three year period following the closing. FIG. 10 shows a close up of one of the follow up emails of FIG. 9, as well as a schedule of when follow up emails will be sent. Each follow up email includes an interesting fact, special note, or greeting, etc., a picture and contact information for the loan officer, and links to send the loan officer an email or to visit the loan officer's website.

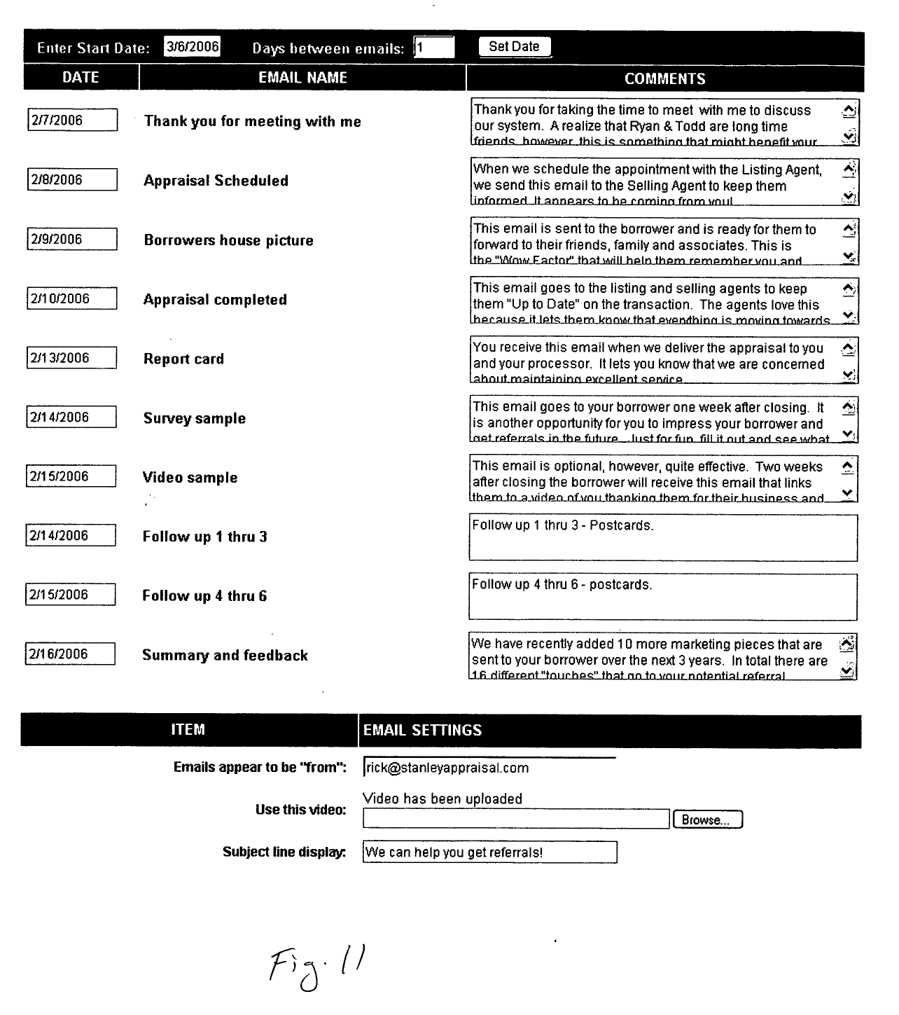

FIG. 11 shows a screen shot of a preferred embodiment of the instant invention in the form of a website that includes a marketing function for the appraiser's services. In the preferred embodiment after an appraiser makes a sales call on a loan officer at a mortgage company, the appraiser uploads the photo of the loan officer to the web site database of the instant invention. The web site then emails the loan officer ten emails over ten days that illustrate each component of the system of the instant invention. This allows the loan officer to experience directly the ability of the system of the instant invention to benefit the loan officer. This campaign is personalized and allows the appraiser to add personal comments in order to “close” the deal.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of marketing comprising the steps of:
providing a good or service to a customer; and
marketing the goods or services of the customer as a component of the good or service that is provided to the customer.

2. The method as claimed in claim 1 wherein said good or service provided to said customer is an appraisal.

3. The method as claimed in claim 2 wherein said customer is a loan officer of a mortgage company.

4. The method as claimed in claim 1 wherein said marketing comprises an email to a referral source for the customer.

5. The method as claimed in claim 5 wherein said referral source is a borrower.

6. The method as claimed in claim 5 wherein said referral source is a selling agent.

7. The method as claimed in claim 5 wherein said referral source is a listing agent.

8. A method of marketing appraisal services, comprising the steps of:
offering appraisal services to a mortgage company; and
including with the appraisal services marketing services to the mortgage company.

9. A method of marketing mortgage services, comprising the steps of:
conducting an appraisal; and
generating notices to referral sources of a mortgage company based upon events relating to the appraisal.
